(19) United States
(12) Patent Application Publication
(10) Pub. No.: US 2018/0245441 A1
(43) Pub. Date: Aug. 30, 2018

(54) SYSTEMS, METHODS, AND COMPUTER-READABLE MEDIA FOR MAPPING NATURAL FRACTURE NETWORK IN SHALE

(71) Applicant: Intelligent Solutions, Inc., Morgantown, WV (US)

(72) Inventor: Shahab D. Mohaghegh, Morgantown, WV (US)

(21) Appl. No.: 15/443,635

(22) Filed: Feb. 27, 2017

(51) Int. Cl. E21B 43/26; G06N 3/04; G06N 3/08; E21B 41/00

(52) U.S. Cl. CPC E21B 43/26; E21B 41/0092; G06N 3/088; G06N 3/0436

(57) ABSTRACT

Generating a map of a Natural Fracture Network (“NFN”) of a shale reservoir is provided. A set of rules are defined to output an NFN density value, the rules being based on parameters including a well volume/completion parameter, a well stimulation parameter, and a well production parameter, each parameter divided into at least two fuzzy (or hard) clusters. The rules include combinations made up of the plurality of parameters and the fuzzy (or hard) cluster of each parameter, each combination being assigned an NFN density value. Historical data related to a plurality of wells drilled in the shale reservoir is analyzed, where the data includes volume/completion data, stimulation data, and production data. Corresponding values are assigned to the historical data based on the set of rules to determine the NFN density value. The NFN density values are mapped on a graph to identify the NFN of the shale reservoir.

### TECHNICAL FIELD

The present disclosure generally relates to methods and systems for hydraulic fracturing, and in particular, to mapping the natural fracture network in shale.

### BACKGROUND

Shale is a sedimentary rock formed from the compaction of natural materials, such as mud and silt, under pressure over many years. During the formation of certain types of shale, such as black shale, the earth warms the mud and silt to thereby cause organic matter therein to decompose over time into oil and gas. In some cases, the oil and gas migrates to pockets between the shale to form reservoirs. In others, the oil or gas remains in the shale, specifically, in small pores within the shale.

To extract the oil and gas from the shale, oil companies have employed techniques such as hydraulic fracturing. In this regard, a well site first is drilled at a location suspected of being within a shale reservoir. A slurry of water, proppant, and other additives are pressurized and introduced into the shale reservoir to thereby release the hydrocarbon, if any, that may have been generated or trapped therein. The pressurized slurry forces the hydrocarbon (by fracturing the rock) to travel through pipes or other delivery mechanisms to the earth's surface for collection at the well site. To fully exploit the potential yield of a shale reservoir, the hydraulic fracturing operation is performed on a first length of the shale reservoir (commonly referred to as a “stage”), then performed on a second adjacent length or stage of the shale reservoir and so on. In some cases, a full length of the shale reservoir is divided into ten to thirty (or more) stages.

The Natural Fracture Network (NFN) of the shale reservoir is a significant contributor to well productivity in shale wells. As such, opening existing networks of natural fractures before (or along with) creating new fractures in shale improves well productivity.

### SUMMARY

As shale well productivity is at least partially based on the NFN of a shale reservoir, there is a need for a method of mapping the NFN of a shale reservoir. The following methods and computer-readable medium storing the methods, address the aforementioned need.

According to an aspect of the present disclosure, systems and methods are provided that address the above mentioned needs.

In an embodiment, a method of generating a map of a Natural Fracture Network (“NFN”) of a shale reservoir is provided. The method includes defining a set of rules to output an NFN density value, the set of rules based on a plurality of parameters including a well volume/completion parameter, a well stimulation parameter, and a well production parameter, each parameter divided into at least two fuzzy clusters, wherein the set of rules includes a plurality of combinations made up of the plurality of parameters and the fuzzy cluster of each parameter, each combination being assigned an NFN density value. Historical data related to a plurality of wells drilled in the shale reservoir is analyzed, where the data includes volume/completion data, stimulation data, and production data. Corresponding values are assigned to the historical data based on the set of rules to thereby determine the NFN density value of each of well. The NFN density value of each well is mapped on a graph to thereby identify the NFN of the shale reservoir, and the graph is displayed as the map.

In an aspect of the embodiment, each of the well volume/completion parameter, the well stimulation parameter, and the well production parameter are divided into three fuzzy clusters.

In another aspect of the embodiment, each combination is assigned a truth value, and the NFN value is based, in part, on the truth value.

In still another aspect of the embodiment, the well volume/completion parameter is generated from one or more of a well spacing along a lateral length of the hydraulic fracturing job, a bulk volume of the hydraulic fracturing job, initial water saturation to calculate a hydrocarbon pore volume of the hydraulic fracturing job, an initial pressure used in the hydraulic fracturing job, a TOC, or a total number of stages included in the hydraulic fracturing job.

In another aspect of the embodiment, the well stimulation parameter is generated from one or more of an amount of proppant used in the hydraulic fracturing job or an amount of fluid used in the hydraulic fracturing job.

In another aspect of the embodiment, the well production parameter is generated from one or more of a well-head pressure used during a hydraulic fracturing job, an initial reservoir pressure used during the hydraulic fracturing job, or a 180 days cumulative production amount obtained from the hydraulic fracturing job.

In another aspect of the embodiment, the shale reservoir includes a developed portion and an undeveloped portion, the developed portion includes the plurality of wells, and the method includes imposing a Cartesian (or other type of) grid on the generated map, selecting seismic attributes from a seismic map of the shale reservoir, using the seismic attributes and NFN density values of the developed portion to design, train, calibrate, and validate a neural network model, deploying neural network model in a forecast mode, setting the seismic attributes of the undeveloped portion to generate NFN density values for the shale reservoir including the undeveloped portion, and generating the map using the NFN density values generated for the undeveloped portion.

According to another embodiment, a non-transitory computer-readable medium is provided storing instructions, which when executed, cause a processor to perform a method of generating a map of a Natural Fracture Network (“NFN”) of a shale reservoir. The method includes defining a set of rules to output an NFN value, the set of rules based on a plurality of parameters including a well volume/completion parameter, a well stimulation parameter, and a well production parameter, each parameter divided into at least two fuzzy clusters, wherein the set of rules includes a plurality of combinations made up of the plurality of parameters and the fuzzy cluster of each parameter, each combination being assigned an NFN density value, analyzing historical data related to a plurality of wells drilled in the shale reservoir, the data including volume/completion data, stimulation data, and production data, assigning corresponding values to the historical data based on the set of rules to thereby determine the NFN density value of each of well, mapping the NFN density value of each well on a graph to thereby identify the NFN of the shale reservoir, and displaying the graph as the map.

In an aspect of the embodiment, each of the well volume/completion parameter, the well stimulation parameter, and the well production parameter are divided into three fuzzy clusters.

In another aspect of the embodiment, each combination is assigned a truth value, and the NFN value is based, in part, on the truth value.

In still another aspect of the embodiment, the well volume/completion parameter is generated from one or more of a well spacing along a lateral length of the hydraulic fracturing job, a bulk volume of the hydraulic fracturing job, initial water saturation to calculate a hydrocarbon pore volume of the hydraulic fracturing job, an initial pressure used in the hydraulic fracturing job, a TOC, or a total number of stages included in the hydraulic fracturing job.

In still another aspect of the embodiment, the well stimulation parameter is generated from one or more of an amount of proppant used in the hydraulic fracturing job or an amount of fluid used in the hydraulic fracturing job.

In yet another aspect of the embodiment, the well production parameter is generated from one or more of a well-head pressure used during a hydraulic fracturing job, an initial reservoir pressure used during the hydraulic fracturing job, or a 180 days cumulative production amount obtained from the hydraulic fracturing job.

In still yet another aspect of the embodiment, the shale reservoir includes a developed portion and an undeveloped portion, the developed portion includes the plurality of wells, and the method further comprises imposing a Cartesian (or other type of) grid on the generated map, selecting seismic attributes from a seismic map of the shale reservoir, using the seismic attributes and NFN density values of the developed portion to design, train, calibrate, and validate a neural network model, deploying neural network model in a forecast mode, setting the seismic attributes of the undeveloped portion to generate NFN density values for the shale reservoir including the undeveloped portion, and generating the map using the NFN density values generated for the undeveloped portion.

### BRIEF DESCRIPTION OF THE DRAWINGS

The above and other aspects, features, and advantages of the present disclosure will become more apparent in light of the following detailed description when taken in conjunction with the accompanying drawings, in which:

FIG. 1 is a flow diagram of a method of generating a map of the Natural Fracture Network (NFN) in shale, according to an embodiment;

FIG. 2 is a graph illustrating fuzzy clustering of a “well-productivity” parameter used in generating a map of the NFN a plurality of wells of a shale reservoir, according to an embodiment;

FIG. 3 is a graph indicating the locations of the small, average, and large hydraulic fracturing jobs shown on a cross plot of proppant versus fluid per foot, according to an embodiment;

FIGS. 4 and 5 are bar graphs illustrating values of cluster centers of the small, average, and large hydraulic fracturing jobs shown for fluid and proppant per foot, according to embodiments;

FIGS. 6-11 are graphs indicating the locations of small, medium, and large volume/completions shown on cross plots, according to embodiments;

FIGS. 12-15 are bar graphs illustrating values of cluster centers small, medium, and large volume/completions shown for hydrocarbon pore volume, initial pressure, TOC and number of stages, according to embodiments;

FIG. 16 is a graph showing a linear, a logarithmic (early impact), or an exponential (late impact) model for the presence and extent of NFN and well productivity, according to an embodiment;

FIG. 17 is a chart illustrating rules that govern the distribution of Natural Fracture

Network in shale formations in the linear model), according to an embodiment;

FIG. 18 are graphs illustrating fuzzy membership values for volume/completion, stimulation, and productivity variables for a well, according to an embodiment;

FIG. 19 includes graphs illustrating a fuzzy interference engine combining the fuzzy membership values of each of the volume/completion, stimulation, and productivity variables for the well analyzed in FIG. 18 and the resulting NFN fuzzy membership values output;

FIG. 20 is a chart illustrating the set of four rules representing all the fuzzy membership values for the volume/completion, stimulation, and productivity variables of FIG. 19;

FIG. 21 is a graph illustrating a “Center of Mass” technique to defuzzify the fuzzy membership values output from the fuzzy interference engine of FIG. 19;

FIG. 22 is a map of the Natural Fracture Network for an asset in a shale reservoir, according to an embodiment;

FIG. 23 is a flow diagram of a method of generating a map of the Natural Fracture Network (NFN) in shale for an undeveloped portion of a shale field, according to another embodiment; and

FIG. 24 is a schematic diagram of a computing device, in accordance with an embodiment.

### DETAILED DESCRIPTION

As noted briefly above, the Natural Fracture Network (NFN) in shale is a significant contributor to well productivity in shale wells. The most significant contribution of inducing hydraulic fractures for the extraction of hydrocarbons is to open the existing network of natural fractures before (or along with) creating new fractures in shale. To determine the location of NFN in shale, engineers and scientist have used seismic surveys and stochastic modeling as inspiration. For example, in numerical reservoir simulation, the NFN is modeled using a stochastic approach. In particular, using information that sometimes may be available from wellbore image logs, or using information from outcrops, important parameters that are needed to randomly generate NFN models are assumed such as fracture density, size, and orientation, etc. Further, core analysis and seismic survey have also been used to define natural fracture distribution in formations and to help model the geometry of their network in shale. However, it is impossible to map the NFN in shale (or any other formation, for that matter) through direct measurements.

The presence and the extent of the Natural Fracture Network determine the productivity of a shale well. Parameters that impact the productivity of shale wells are:
Well Construction & Trajectory Characteristics: represented by well location (latitude and longitude), well geometry, percent in formation, inclination, azimuth, up-dip/down-dip, fault intersection, and the like;
Reservoir Characteristics: represented by well logs, porosity, thickness, water saturation, TOC, geo-mechanical properties, etc., and Natural Fracture Network (NFN)
Completion Characteristics: represented by lateral length, number of stages, stage length, number of clusters per stage, distance between stages, shot density, and the like;
Stimulation/Hydraulic Fracturing Characteristics: represented by: type and amount of fluid, type and amount of proppant, proppant size and concentration, injection rate and injection pressure, and the like;
Characteristics related to Operational Constraints: represented by choke size, well-head (casing and tubing) pressure, and the like; and
Well Productivity Characteristics: represented by production (volume) profile and/or cumulative production.

Systems and methods are now provided that can be used to map the NFN in shale. The system and methods take into account the characteristics of the reservoir rock (shale) to determine the degree by which a combination of the completion characteristics and stimulation/hydraulic fracturing characteristics results in a shale well productivity. The systems and methods of the present disclosure employ the characteristics of the reservoir rock (shale) include parameters that can be and are measured, such as well logs, porosity, initial water saturation, formation thickness, total organic carbon (TOC), and the like, and that cannot be directly measured. If, when comparing similar parameters for two wells, the parameters appear to be substantially similar except one well displays a higher productivity than the other and a distinction cannot be identified with all measured reservoir characteristics (for example, total vertical depth drilled (TVD), porosity, initial water saturation, formation thickness, neutron porosity, gamma ray measurement, deep resistivity, density, TOC, and volume of clay (VCL)), then a determination is made that NFN may be affecting the well productivity. In an embodiment of the present invention, field measurements are used in order to generate a map of the “Effective” Natural Fracture Network, which may be used to explain an observed discrepancy between two wells.

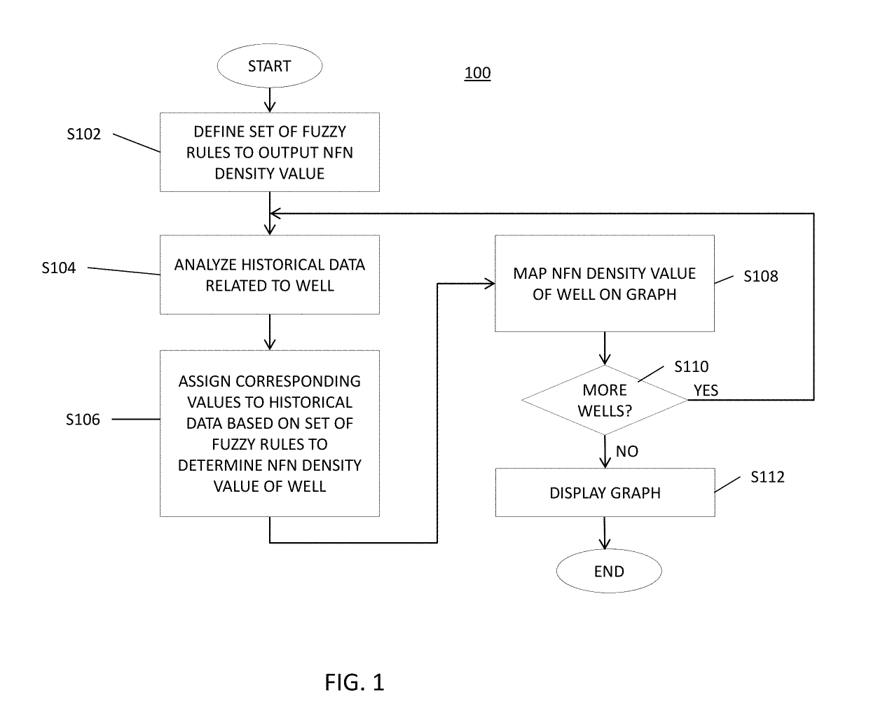

FIG. 1 is a method 100 of generating a map of the NFN of a shale reservoir, according to an embodiment. The method 100 includes defining a set of rules to output an NFN density value, at step S102. The set of rules may be “fuzzy rules,” such as artificial-intelligence- related rules, those based on fuzzy systems or on Bayesian systems. The set of rules based on a plurality of parameters, where the parameters are categories that capture certain characteristics of a hydraulic fracturing job (“frac job”) performed at a shale well of the shale reservoir. According to an embodiment, the plurality of parameters include “well-productivity,” “stimulation,” and “volume/completion.” Each of these parameters includes sub-parameters of the frac job. As will be discussed in more detail below, each parameter is divided into at least two fuzzy clusters, and the set of rules includes a plurality of combinations made up of the plurality of parameters and the fuzzy cluster of each parameter so that each combination is assigned an NFN density value. After the set of rules is defined, historical data related to a well of interest is analyzed at step S104. The historical data includes data that is that same type of data considered for the plurality of parameters. In particular, data related to “well-productivity,” “stimulation,” and “volume/completion” and data from the sub-parameters of each is analyzed. Values are then assigned to the historical data based on the set of rules at step S106. The assigned values are used in determining the NFN density value of the well. The determined NFN density value of the well is mapped onto a graph at step S108. After mapping the NFN density value, a determination is made as to whether more wells are to be analyzed at step S110. If so, the method 100 reiterates at step S104. If not, the graph is displayed at step S112 and method 100 ends. Each of these steps will now be discussed in detail below.

Returning to step S102, the plurality of parameters for the set of rules are based on the sub-parameters of each parameter. Each parameter is divided into classes or clusters. The clusters used in this analysis may be “fuzzy (soft) clusters or crisp (hard) clusters” because they do not have crisp boundaries and may overlap each other. In dividing the “well productivity” into fuzzy clusters, each sub-parameter is considered. For example, the sub-parameters taken into account for “well-productivity” include, but are not limited to, the well-head pressure applied during the frac job, the initial reservoir pressure applied during the frac job (may be presented by TVD as a proxy), and the average cumulative production (BOE) of the frac job over 180 days. When the three sub-parameters are taken together in consideration for the “well-productivity” parameter, a pressure-corrected production indicator may then be provided.

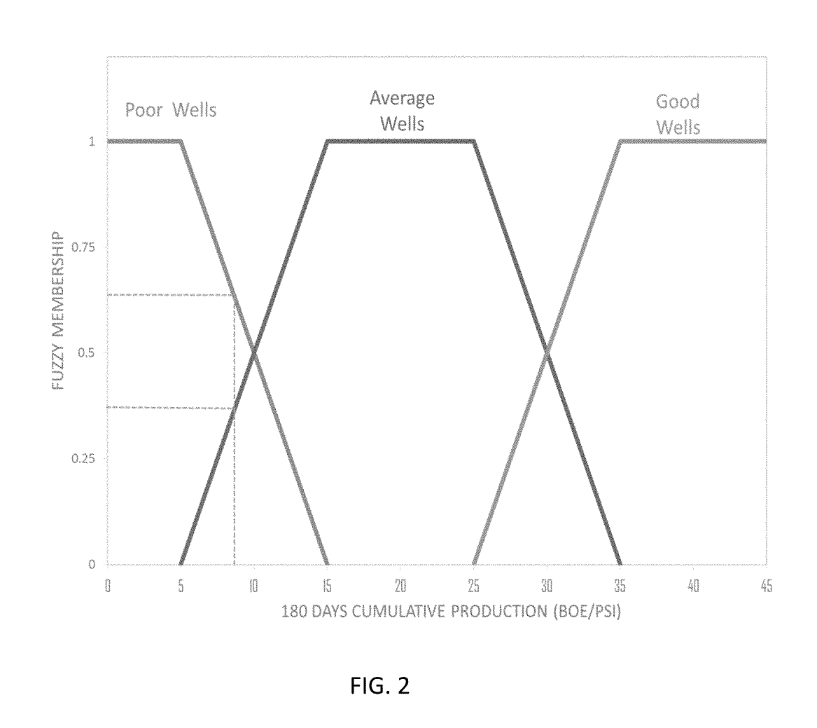

With reference to FIG. 2, a graph is provided showing fuzzy clustering of the “well-productivity” parameter for a plurality of wells of a shale reservoir, according to an example. Here, the “well productivity” parameter is represented by 180 days of cumulative BOE, initial pressure, and well-head pressure. In particular, the “well productivity” is calculated based on the average cumulative production over 180 days (BOE) per psi. The calculated well productivity is then divided into fuzzy clusters, three here, of wells with poor, average and good productivity. Here, wells with productivity from about 0 to about 5 BOE per psi provide 100% membership in the fuzzy cluster of “poor”, and wells with a productivity from about 5 to about 15 BOE per psi share membership with wells in the “average” fuzzy cluster. If membership in the fuzzy cluster of wells with poor productivity is established as having a maximum of 100% at 5 BOE per psi to a minimum of 0% at 15 BOE per psi, the “average” productivity fuzzy cluster may be represented by wells that have productivity from about 5 to about 35 BOE per psi, where from about 15 to about 25 BOE per psi provides a 100% membership in the “average” fuzzy cluster. In another embodiment, if sharing membership with wells of poor productivity of about 5 to about 15 BOE per psi, the membership of wells in the “average” productivity fuzzy cluster changes from a maximum of 100% at 15 BOE/psi to a minimum of 0% at 5 BOE per psi. In still another embodiment, when sharing membership with wells of “good” productivity fuzzy cluster of about 25 to about 35 BOE per psi, the membership of wells in the “average” productivity fuzzy cluster changes from a maximum of 100% at 25 BOE/psi to a minimum of 0% at 35 BOE per psi, and “good” productivity fuzzy cluster is represented by wells that have productivity from about 25 to about 45 BOE per psi, where 34 to 45 BOE per psi provides 100% membership in the “good” fuzzy cluster, and 25 to 35 BOE per psi shares membership with wells having average productivity. The membership in the “good” fuzzy cluster changes from a maximum of 100% at 35 BOE per psi to a minimum of 0% at 25 BOE per psi. It will be appreciated that the range and values that distinguishes between the fuzzy clusters are project dependent, where the project includes all wells in a shale asset.

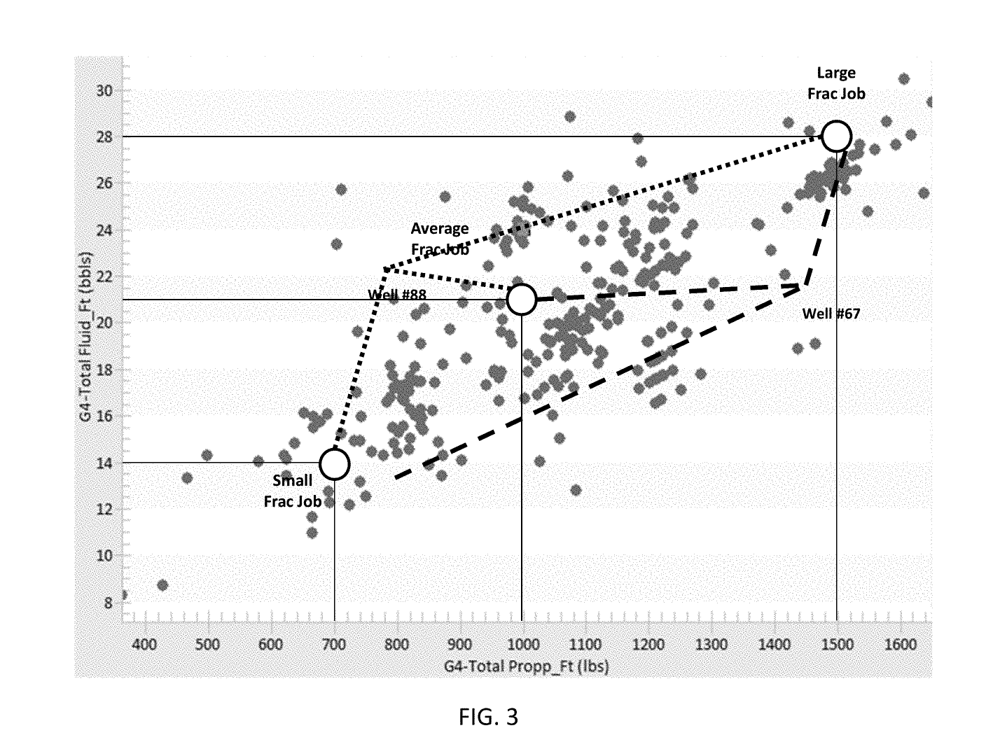

The sub-parameters considered for “stimulation” include but are not limited to the amount of fluid in barrels per foot of lateral length and the amount of proppant in pounds per foot of lateral length used in the frac job. These sub-parameters are used to represent the quality of the hydraulic fracturing. As such, other parameters that may better represent the quality of the frac job can also be included in this parameter category. In an example using the amount of fluid in barrels per foot of lateral length and the amount of proppant in pounds per foot of lateral length, a supervised fuzzy cluster analysis is used to divide the “stimulation” parameter into three overlapping clusters small, average and large hydraulic jobs. The centers of each cluster are determined and imposed on the algorithm (i.e. supervised) in order to complete the supervised fuzzy cluster analysis. For example, with reference to the graph depicted in FIG. 3, a regression analysis performed to output a graph where the amount of fluid in barrels per foot of lateral length used in a frac job is set at the y-axis, and the amount of proppant in pounds per foot of lateral length used in the frac job is set at the x-axis. Each point on the graph represents the size of a frac job for each well, and the locations of cluster centers are shown in a cross plot on the graph. The Euclidian distance of each point (well) to each cluster center determines the membership of the stimulation for that well in each of the three clusters. As illustrated in the graph, Well #67 has a much larger membership in the cluster of large frac jobs (due to its smaller Euclidian distance to the large frac job cluster center than to the average or small frac job cluster centers. Well #88 has substantially similar memberships in the clusters of small and average frac jobs and a somewhat smaller membership in the cluster of large frac jobs.

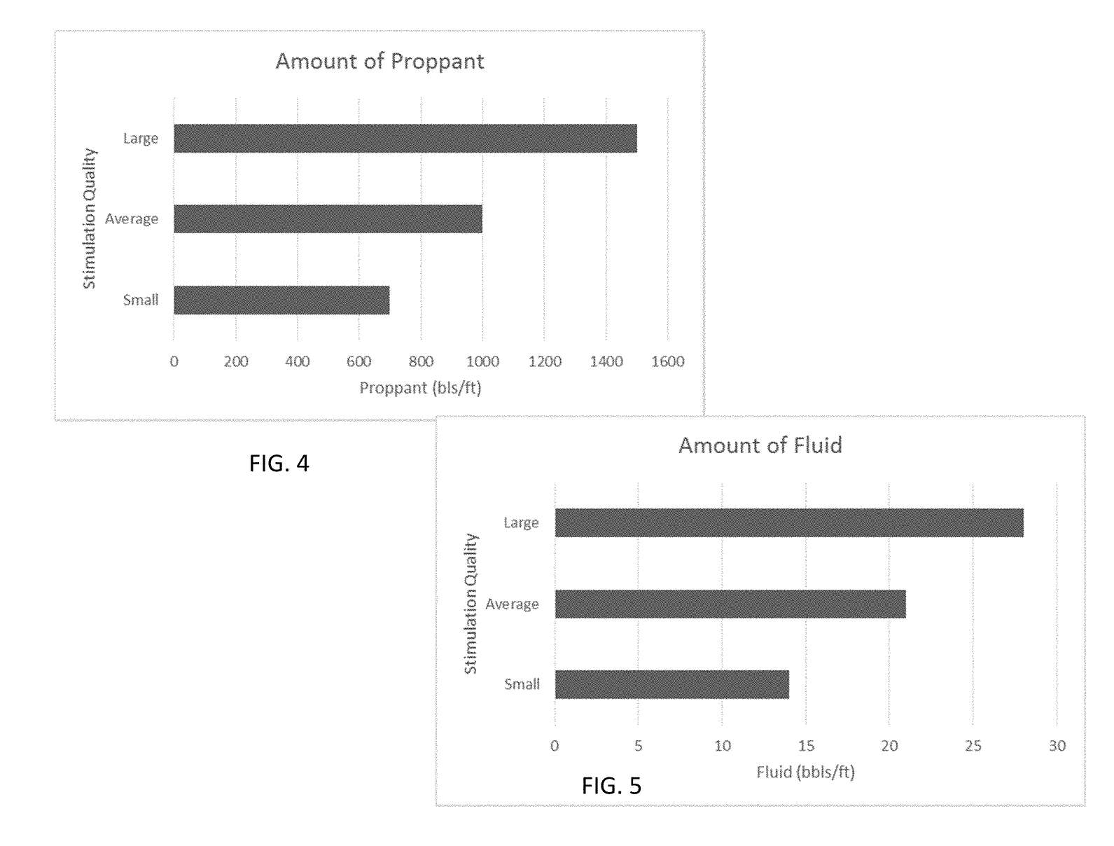

To verify the results, bar graphs are used, as depicted in FIGS. 4 and 5. For example, in FIG. 4, the amount of proppant in pounds per foot of lateral length used in a frac job up to about 700 lbs/ft is identified as a small job, up to about 1000 lbs/ft is identified as an average job, and up to about 1500 lbs/ft is identified as a large job. As shown in the bar graph depicted in FIG. 5, the amount of fluid in barrels per foot of lateral length used in a frac job of up to about 14 lbs/ft is identified as a small job, up to about 21 lbs/ft is identified as an average job, and up to about 27 lbs/ft is identified as a large job.

The “volume/completion” parameter represents the quality and the size of the shale reservoir, along with the completion practices incorporated for the frac job. Sub-parameters for this category include, but are not limited to, well spacing, the lateral length and formation thickness of the well for calculating bulk volume, porosity and initial water saturation for calculating the Hydrocarbon Pore Volume (HCPV) of the shale reservoir, the initial pressure of the frac job, TOC, and the total number of stages employed for the frac job. In an example, the “volume/completion” parameter, which is represented by eight sub-parameters, namely, well spacing, lateral length, formation thickness, porosity, initial water saturation, TOC, initial pressure, and number of stages, is analyzed by using five of the eight sub-parameters (namely, well spacing, lateral length, formation thickness, porosity, and initial water saturation) to calculate the hydrocarbon pore volume (HCPV) identified as one integrated sub-parameter. The other three sub-parameters (TOC, initial pressure, and number of stages) are then entered into the analysis and interacted with the HCPV integrated sub-parameter to form the clusters representing the volume/completion. Using supervised fuzzy cluster analysis the each subparameter of the volume/completion parameter is divided into three overlapping clusters of small, medium, and large volume/completions.

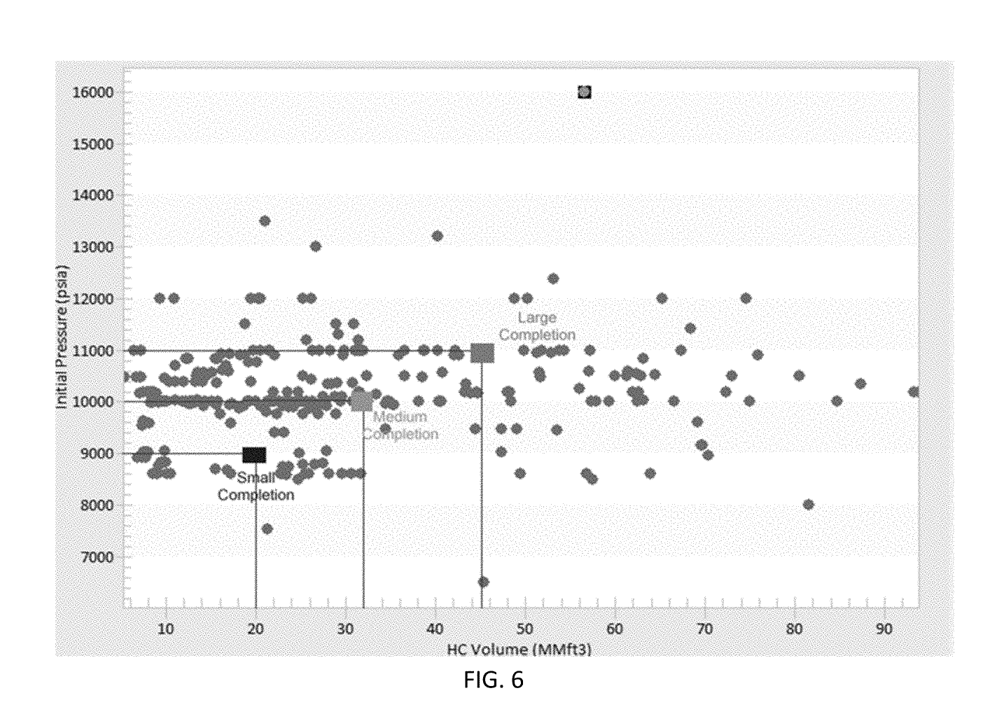

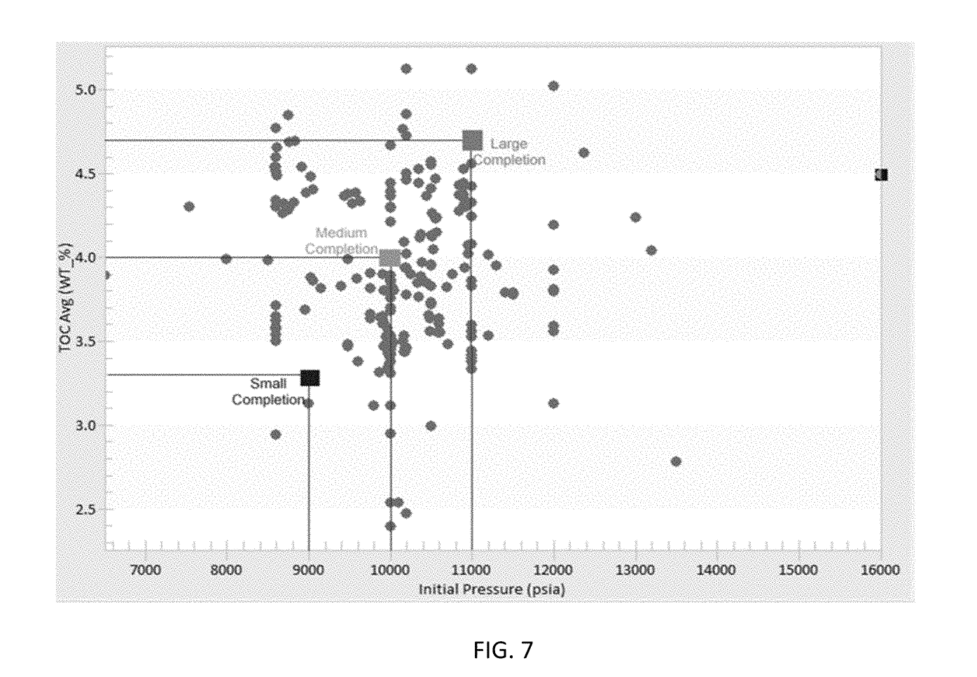

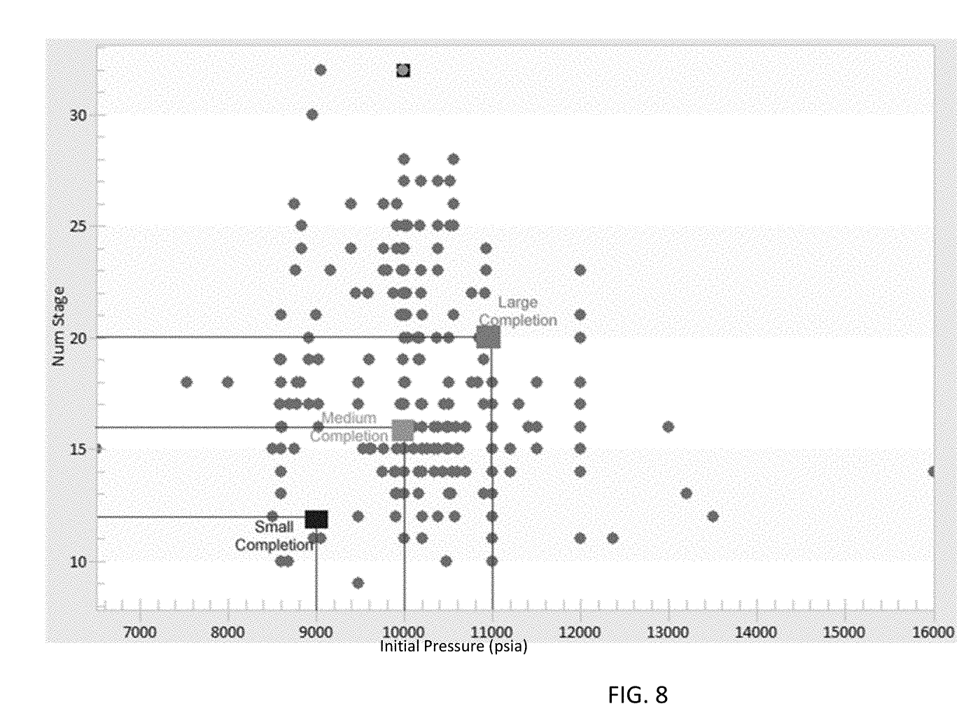

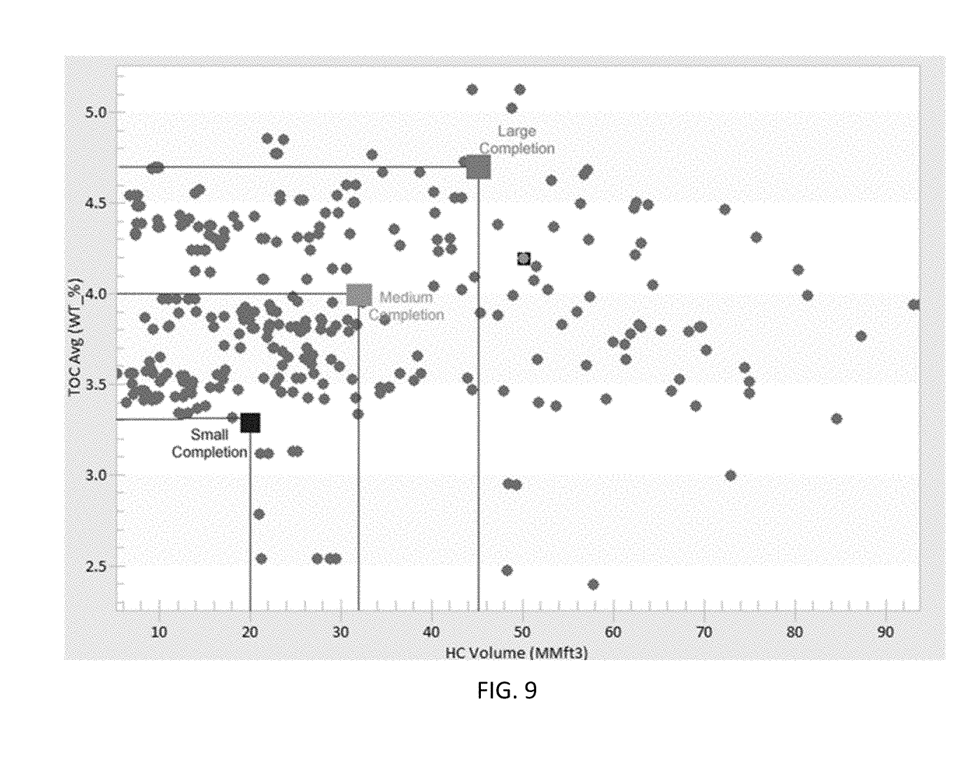

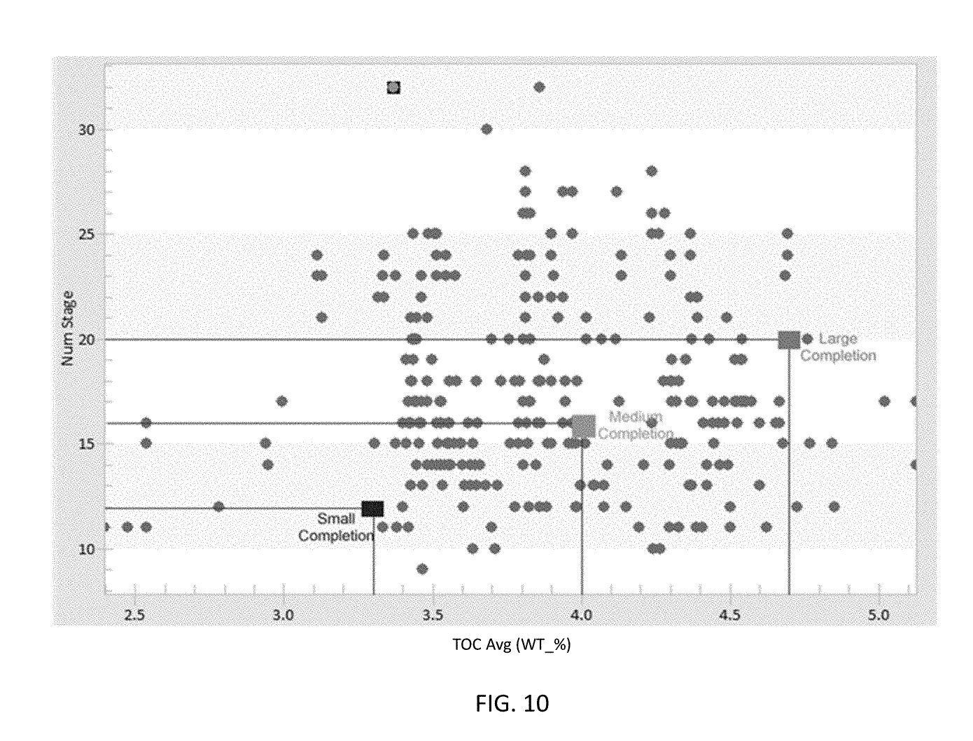

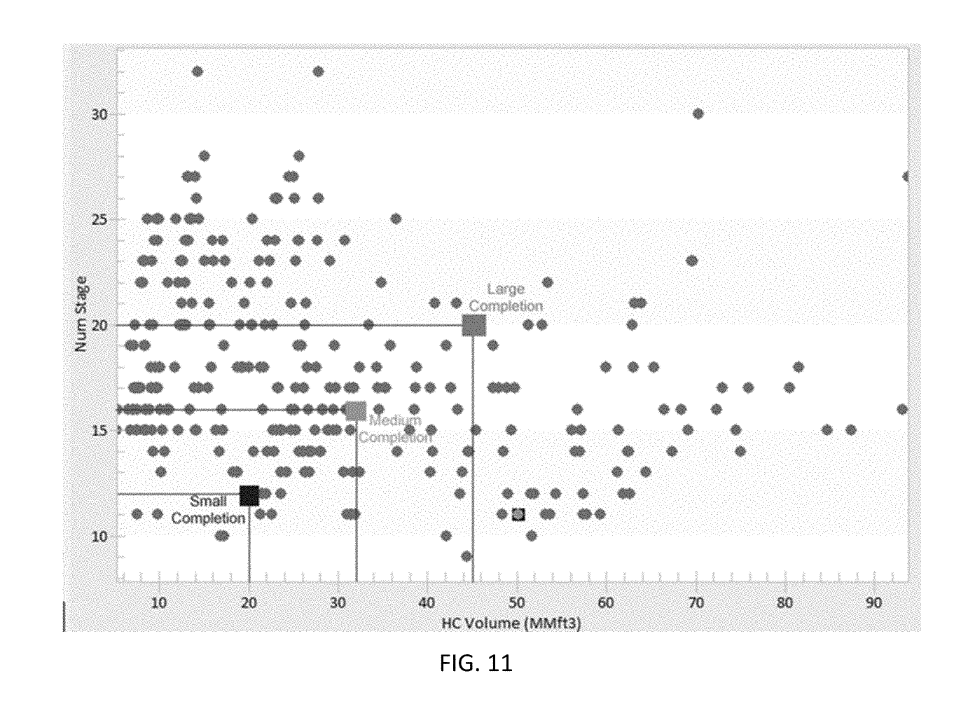

The cluster centers for small, medium, and large volume/completions are determined by using a process which includes cross plotting all the involved sub-parameters against one another and identifying the location of each cluster center. An example of this process is shown in the graphs depicted in FIGS. 6 through 11. FIG. 6 is a graph of the initial pressure plotted against the TOC. FIG. 7 is a graph of the HCPV of each well is plotted against the initial pressure. FIG. 8 is a graph of the initial pressure plotted against the number of stages. FIG. 9 is a graph of the HCPV of each well plotted against the TOC. FIG. 10 is a graph of TOC plotted against the number of stages. FIG. 11 is the HCPV of each well plotted against the number of stages. In each of the graphs shown in FIGS. 6 through 11, the cluster centers indicating the locations of the small, medium, and large completions are shown.

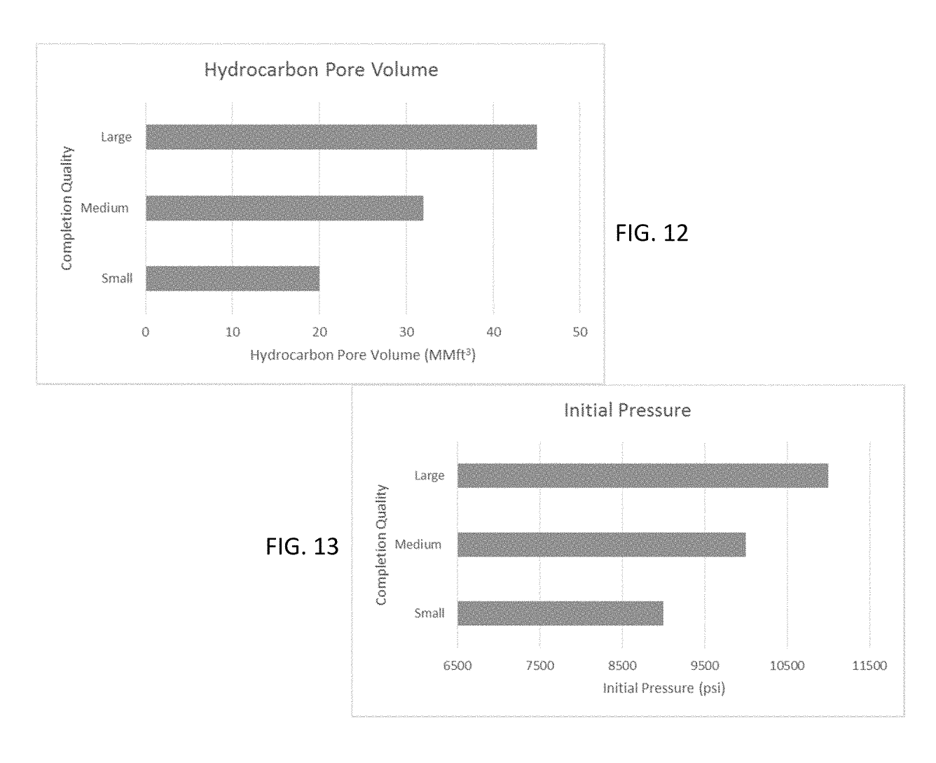

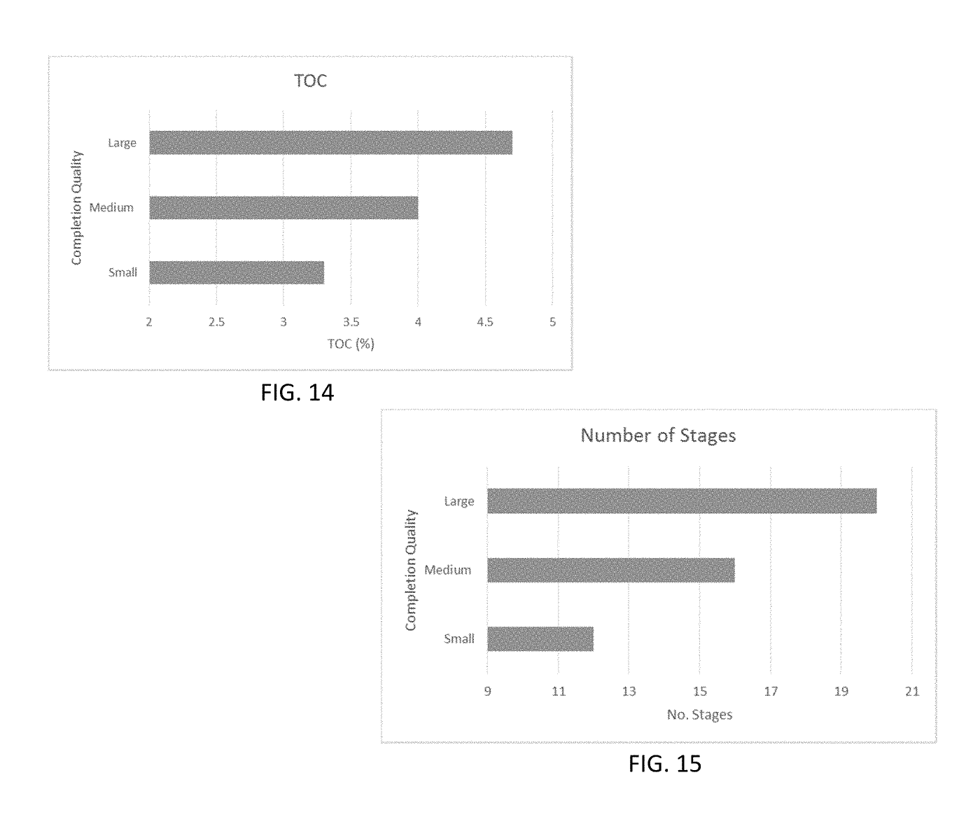

Once the process of determining the location of cluster centers is completed, the values of each cluster center are plotted in bar graphs to demonstrate that the multi-dimension attributed to each cluster center is internally consistent. For example, the values of HCPV (FIG. 12), initial pressure (FIG. 13), TOC (FIG. 14), and number of stages (FIG. 15) for each of the small, medium, and large volume/completion cluster centers are graphed. Using bar graphs, the available hydrocarbon volume (i.e., hydrocarbon pore volume), initial pressure, TOC, and number of stages for each well is measured against these cluster centers, and each well is tagged with a series of membership functions determining the degree of their membership in each of these clusters (depending on its closeness to the cluster center), in terms of available hydrocarbon volume and how they have been completed, to each of the cluster centers that have been defined. For example, as shown in the bar graph in FIG. 12 for the HCPV subparameter, the HCPV in a frac job up to about 20 MMft³ is identified as a small job, up to about 31 MMft³ is identified as an average job, and up to about 48 MMft³ is identified as a large job. For the initial pressure subparameter as depicted in FIG. 13, an initial pressure of up to about 8000 psi is identified as a small job, of up to about 9000 psi is identified as an average job, and up to about 10000 psi is identified as a large job. For the TOC subparameter as depicted in the bar graph in FIG. 14, a TOC of up to about 3.3% is identified as a small job, of up to about 4.0% is identified as an average job, and up to about 4.6% is identified as a large job. As depicted in FIG. 15, up to 12 stages is identified as a small job, of up to 16 stages is identified as an average job, and up to 20 stages is identified as a large job.

The plurality of parameters, namely, “well-productivity,” “stimulation,” and “volume/completion,” are then compared against clusters into which the Natural Fracture Network (NFN) are divided. In an embodiment, the presence and extent of the NFN is divided into three clusters of Minimal, Average, and Extensive. The NFN classes are qualitatively correlated to classes of well productivity based on the assumption that all other parameters are similar. In this regard, in an embodiment, an assumption is made that with all other parameters being equal, higher well productivity is expected in the presence of extensive NFN, or lower well productivity is expected in the presence of minimal NFN.

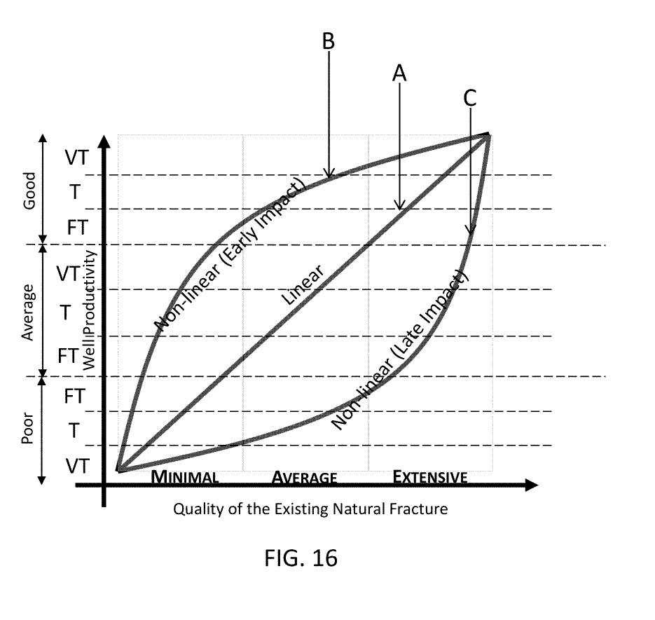

If a qualitatively linear relationship is further assumed between presence and the extent of the Natural Fracture Network and well productivity (all other parameters being similar), then a qualitative plot, such as one shown in FIG. 16 can be inferred. In this figure several items has been established as assumptions, such as:
Assuming all other parameters (hydrocarbon volume available to a well, how the well is completed and hydraulically fractured) being similar, there is a qualitatively linear relationship between the presence and the extent of the Natural Fracture Network and well productivity;
Assuming all other parameters (hydrocarbon volume available to a well, how the well is completed and hydraulically fractured) being similar, when the presence and the extent of the NFN is minimal, the expected well productivity is poor;
Assuming all other parameters (hydrocarbon volume available to a well, how the well is completed and hydraulically fractured) being similar, when the presence and the extent of the NFN is average, the expected well productivity is also average; and
Assuming all other parameters (hydrocarbon volume available to a well, how the well is completed and hydraulically fractured) being similar, when the presence and the extent of the NFN is extensive, the expected well productivity is good.

Each statement regarding the relationship between well productivity and NFN is further qualified (granulized) with a “truth value”. Given that the relationships that we have established are qualitative in nature, and the term “similar” is used for hydrocarbon volume, completion, and hydraulic fracturing, the “truth value” can further qualify the statements and the rules that are made during the next step. The “truth value” includes “Very True”, that has a higher truth value than “True”, which has a higher truth value than “Fairly True”.

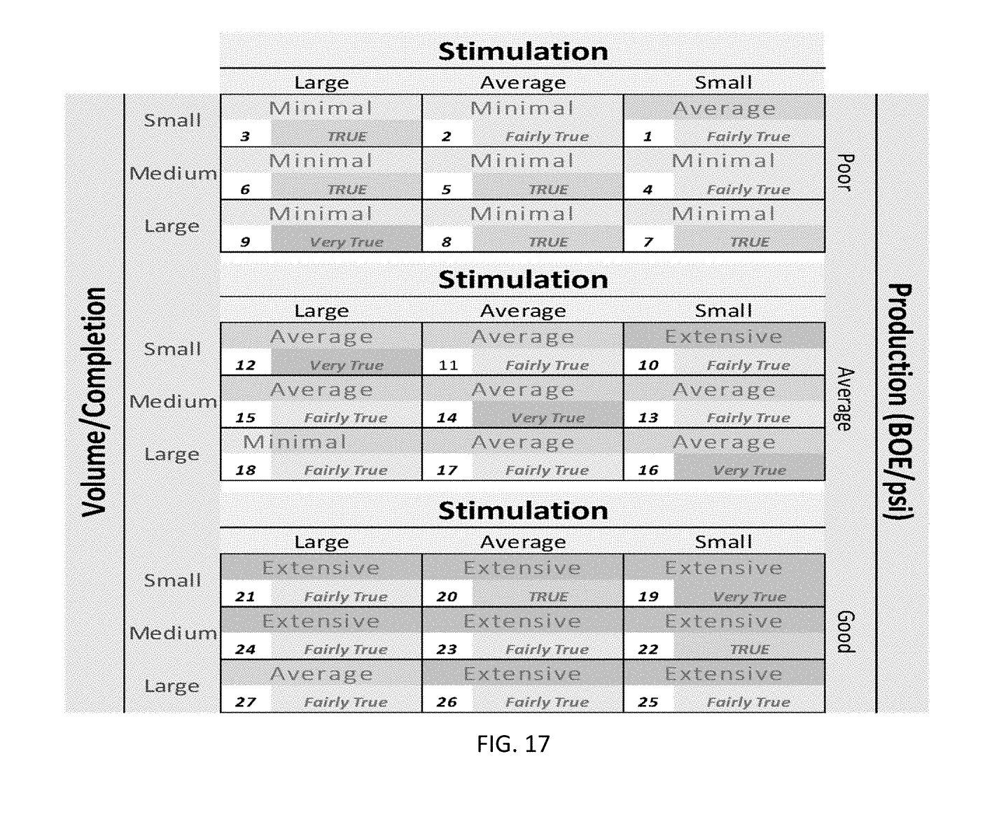

The relationship between the presence and the extent of the NFN and well productivity can be either linear (line A as shown in FIG. 16) or nonlinear. The nonlinear relationship maybe modeled in many different ways. In other embodiments, nonlinear relationships are shown as logarithmic (line B in FIG. 16), or exponential (line C in FIG. 17).

Once the plurality of parameters is identified, the fuzzy clusters of each parameter and the NFN and well productivity relationship model are determined, then a set of rules are defined to govern the interaction between all of the parameters. As noted above, in an embodiment, the rules may be based on fuzzy logic. Here, Fuzzy Set Theory is used to define the set of rules; as such, the set of rules are fuzzy rules. Fuzzy rules have two distinct characteristics:
Fuzzy rules incorporate natural language semantics in order to build a set of instructions on how the involved variables must interact. This characteristic of fuzzy set theory removes restrictions that are usually associated with crisp classification of variables.
To make conclusions based on fuzzy rules used in fuzzy inference engines, several of the rules are executed simultaneously and in parallel. The final decision is then made based on the conflict resolution or aggregation of similarity between multiple rules. This allows investigation of a vast number of possible scenarios to be considered at the same time and the final inference to be made in an intelligent fashion.

FIG. 17 shows a collection of 27 rules that are used for mapping of NFN, in accordance with an embodiment. Each of the rules in this figure is qualified with a specific “Truth Value” that distinguishes similar rules from one another. As noted above, the rules may be expressed in natural language. In an example, in natural language Rule #19 states: When a “Small” “Volume/Completion” is available to a shale well, the well is “Stimulated” with a “Small” frac job, and the well demonstrates “Good” “Productivity”, then the “Natural Fracture Network” around this well must be “Extensive”. Relative to other rules that conclude the Natural Fracture Network around a well is Extensive, this Rule #19 is “Very True”. In another example, in natural language Rule #18 states: When a “Large” “Volume/Completion” is available to a shale well, the well is “Stimulated” with a “Large” frac job, and the well demonstrates “Average” “Productivity”, then the “Natural Fracture Network” around this well must be “Minimal”. Relative to other rules that conclude the Natural Fracture Network around a well is Minimal, this rule is “Fairly True”. It should also be mentioned that as few as 9 rules and as many as 18 rules are executed simultaneously and then resolved using a fuzzy inference engine in order to generate a conclusion about a single well, in this operation. The parallel execution of large number of wells helps the robustness of the results generated by this technology.

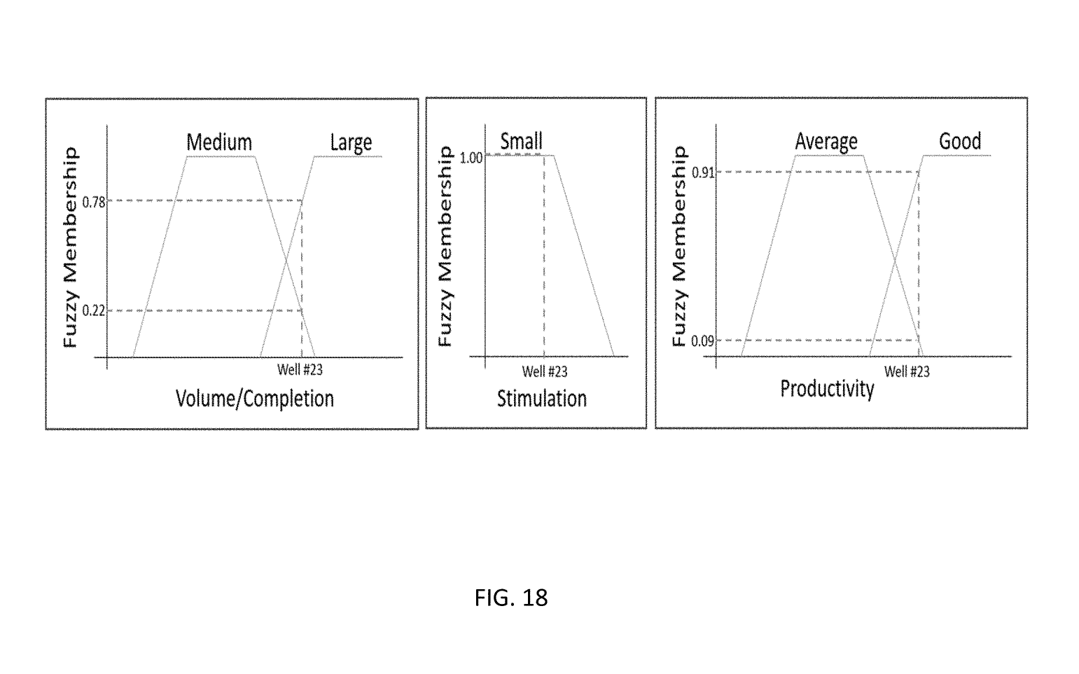

Based on the set of rules, an NFN distribution map may be generated using the following steps:
For each given well (its location in the field), the fuzzy membership values for all three variables (Volume/Completion, Stimulation, Productivity) are identified,
The collection of rules needed to engage all the combinations of the fuzzy membership values of all variables are selected from the list of rules shown in FIG. 18,
The fuzzy membership values, and the corresponding fuzzy rules are used in a fuzzy inference engine in order to generate the set of fuzzy membership values for the NFN,
Using the “Center of Mass” technique (or other techniques) the fuzzy membership values of the NFN defuzzified. This is the NFN density value of the given well location.

As noted briefly above with respect to method 100, after the rules are defined, historical data related to a well is analyzed at step S104. In an example in which “Well #23” in a Marcellus shale field is analyzed, fuzzy membership values for Volume/Completion, Stimulation, and Productivity are identified. With reference to FIG. 18, the Volume/Completion variable includes two fuzzy membership values, 0.22 and 0.78, which fall into “medium” and “large” fuzzy clusters, respectively, the Stimulation variable includes one fuzzy membership value, 1.00, which falls into “small” fuzzy cluster membership, and the Productivity variable includes two fuzzy membership values, 0.09 and 0.91, which fall into “average” and “good” fuzzy clusters, respectively. For the sake of simplicity, an assumption is made that each variable is represented by one or two fuzzy sets, and thus represented by one or two fuzzy membership values.

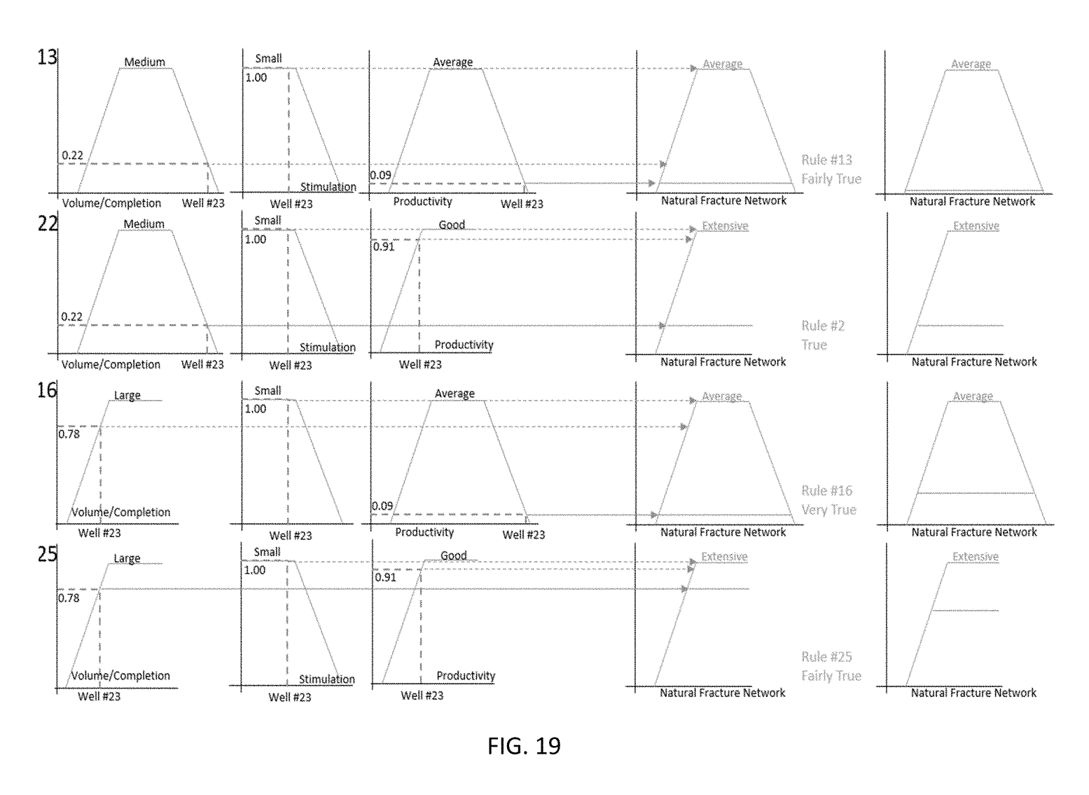

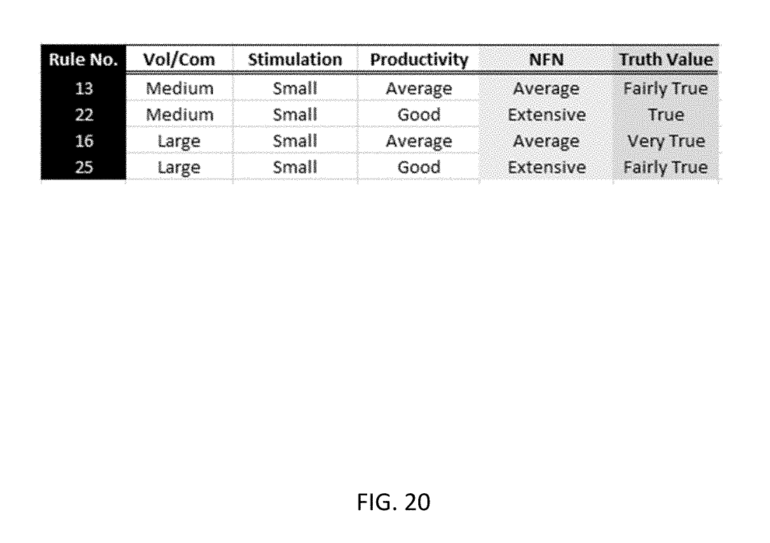

Once the fuzzy membership values are obtained, corresponding fuzzy rules are identified which are used to assign corresponding values to the historical data to determine the NFN density value of the well. In particular, taking the fuzzy membership values of “Well #23” identified above into consideration and with reference to FIG. 17, a Volume/Completion falling into the “medium” fuzzy cluster, a Stimulation falling into the “small” fuzzy cluster, and a Productivity in the “average” fuzzy cluster is matched to a rule assigned with value “13”, where Rule 13 is “Fairly True.” A Volume/Completion falling into the “medium” fuzzy cluster, a Stimulation falling into the “small” fuzzy cluster, and a Productivity in the “good” fuzzy cluster is matched to a rule assigned with value “22”, where Rule 22 is “True.” A Volume/Completion falling into the “large” fuzzy cluster, a Stimulation falling into the “small” fuzzy cluster, and a Productivity in the “average” fuzzy cluster is matched to a rule assigned with value “16”, where Rule 16 is “Very True.” A Volume/Completion falling into the “large” fuzzy cluster, a Stimulation falling into the “small” fuzzy cluster, and a Productivity in the “good” fuzzy cluster is matched to a rule assigned with value “25”, where Rule 25 is “Fairly True.” Graphical representations of a fuzzy inference engine that combines the fuzzy membership value of each of the variables using a given fuzzy rule, and executes them in parallel is shown in FIG. 19. The result of the operation is illustrated in FIG. 20.

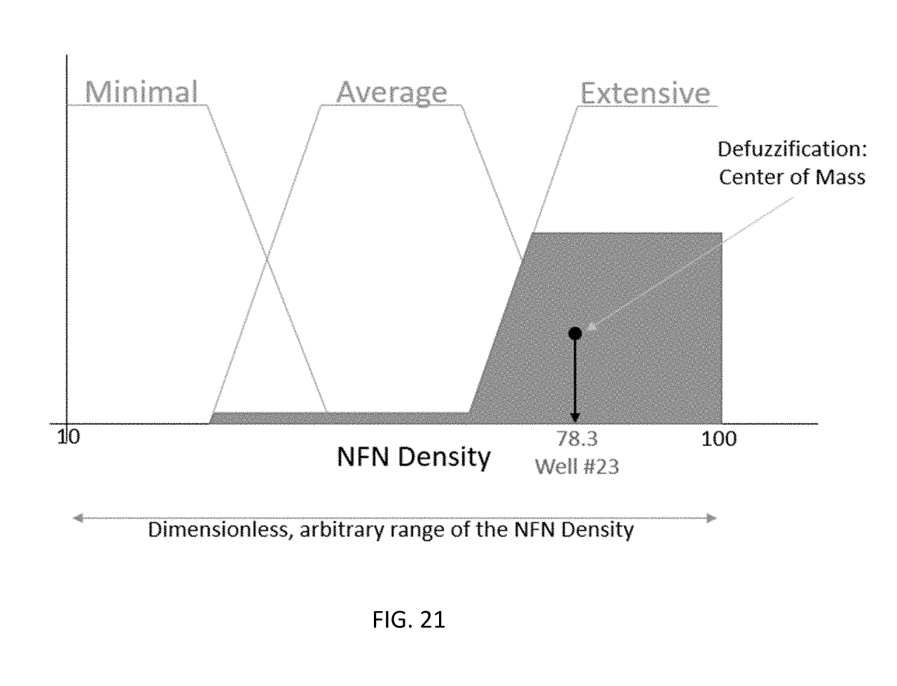

The results of executing all the applicable rules in parallel is the generation of a set of fuzzy membership values for the NFN, as shown in the far right graphs depicted in FIG. 19. These fuzzy membership values of the NFN then are aggregated to represent the fuzzy nature of the NFN for the location of the well being analyzed. For example, in the case of Well #23, because a single value is needed to represent one shale asset when mapping the distribution of the NFN throughout the field, the single value is calculated from the multiple fuzzy membership values of the NFN by using the center of the mass defuzzification technique. This process is illustrated in FIG. 21, which shows that the center of mass of the fuzzy membership values of the NFN from FIG. 19 is 78.6. The center of mass then is provided as a NFN density value. Once the NFN density value is identified, it is mapped onto a graph in step S108. Specifically, once the NFN density value is generated for each well location in the field, they are used as anchor points for a geo-statistical routine to generate the NFN distribution map from the graph for the entire field, which is then displayed at step S112.

### EXAMPLES

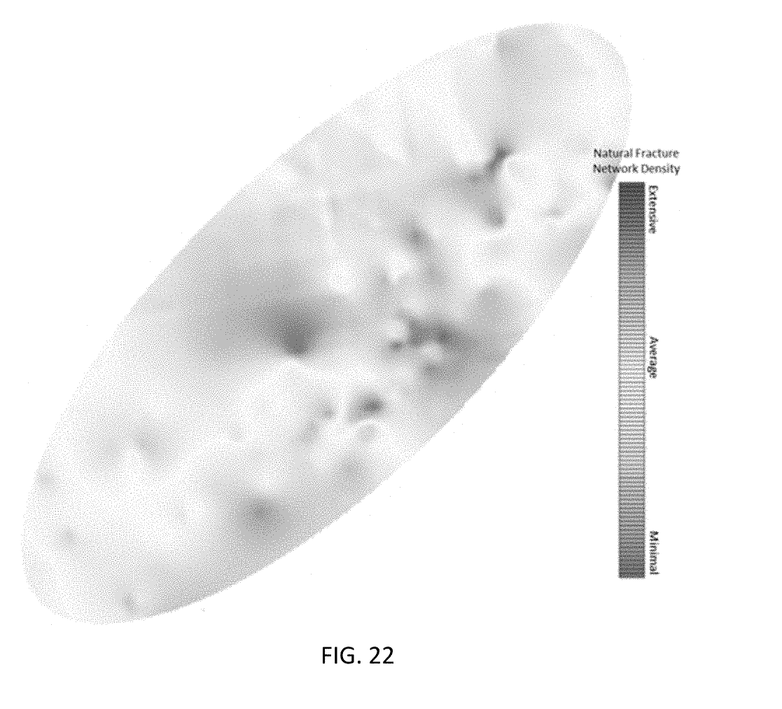

Using Artificial Intelligence, a distribution of the Natural Fracture Network of a shale asset in Eagle Ford was mapped. FIG. 22 shows the Natural Fracture Network distribution generated for this specific location in the Eagle Ford shale. Using the processes described above, results that were generated based on the 27 rules displayed in FIG. 17 were combined with geo-statistics in order to generate the NFN distribution map shown in FIG. 22. The outcome of the Artificial Intelligence system for the distribution of the Natural Fracture Network were scaled from a minimum value of 10 to a maximum value of 100 (dimensionless score—only indicating intensity of the NFN) in order to show the relative distribution of the density of the Natural Fracture Network in this asset.

The heterogeneous nature of the distribution of the Natural Fracture Network that is shown in FIG. 22 demonstrates the complexities associated with the completion, stimulation and production operations of shale wells. Once the distribution of the NFN is mapped the results of this exercise can be put to engineering and geosciences evaluation for future decision making. Also this map can be used as an indication of the sweet spots in the asset.

To demonstrate the accuracy of the results generated by the methods described above, a few examples are provided. In a first example shown below in Table 1, two wells (Well #BJU3 and Well #RF101) having similar volume/completion and similar lateral lengths are compared. Well #BJU3 was stimulated with a proppant of 802 lbs/ft and Well #RF101 was stimulated with a proppant of 466 lbs/ft, and were thus different frac job sizes. However, Well #BJU3, which was treated with a larger frac job, demonstrated less productivity Well #RF101, which was treated with smaller frac job. After applying the algorithm described above, the discrepancy in well productivity can be explained by attributing the difference to the presence and the extent of the Natural Fracture Network throughout this asset. In particular, the algorithm assigns Well #BJU3 with a NFN density value of 65.76 and Well #RF101 with a NFN density value of 84.08.

Table 1 also shows that the well with better productivity is located in a part of the field with higher NFN density (NFN Density score of 84) while the well with lower productivity, although it has been stimulated with a smaller frac job is located in the part of the filed that has lower NFN density (NFN Density score of 66). In other words, when field measurements that are related to the well (for example, how the well is drilled, how much hydrocarbon volume is accessible to it, how it was completed, how big of a frac job was performed and what choke sizes were used to produce it) cannot explain well productivity, then the only characteristic left to attribute to the well productivity is the presence and the extent of the NFN.

After compiling the NFN density values for every well in an asset and applying the above-described reasoning to every other square foot of the asset based on the field measurements of the asset, the map shown in FIG. 22 may be generated. Here, a large amount of historical data from the asset is processed in order to generate a comprehensive and cohesive map of the presence and the extent of the NFN in the asset.

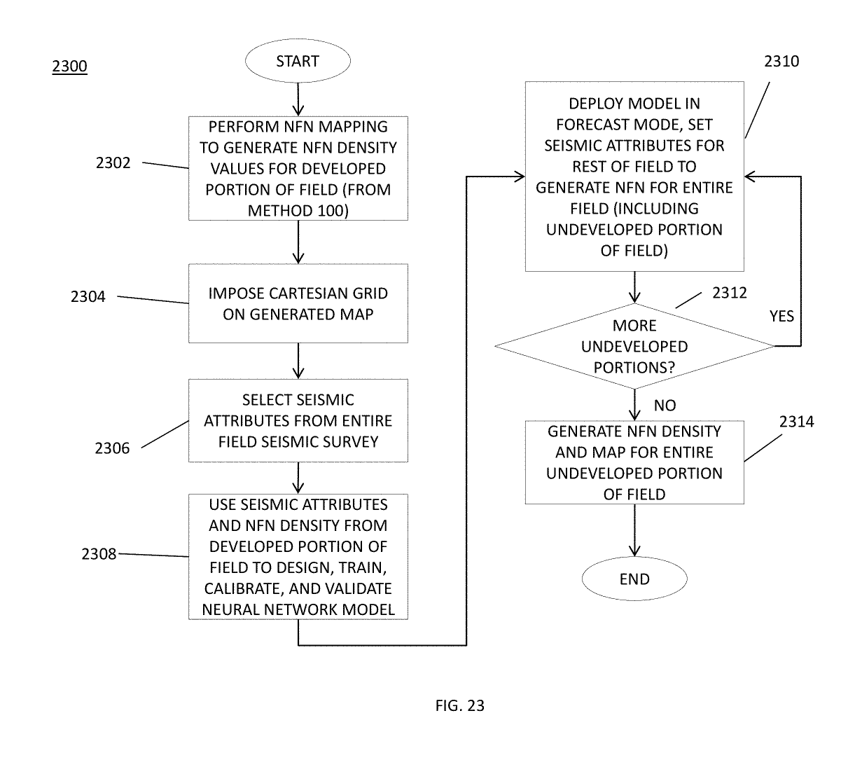

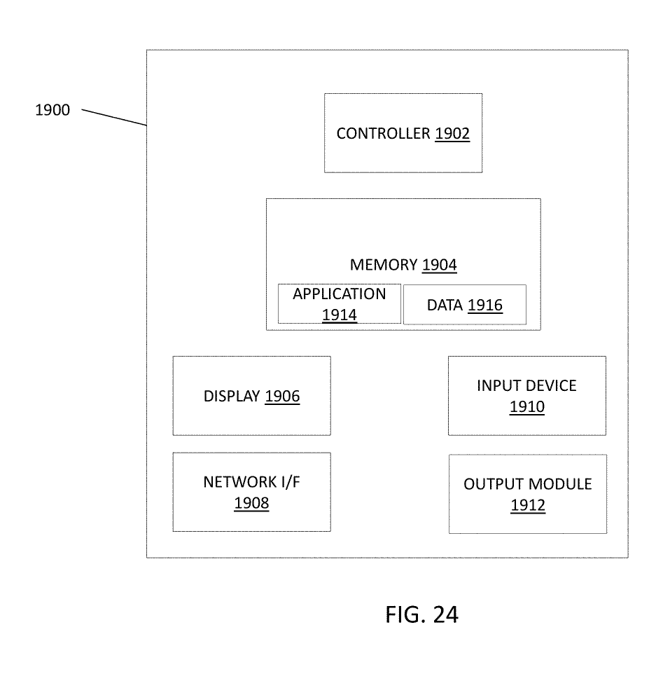

Once the Natural Fracture Network is mapped throughout the part of the field where wells have been completed and are under production, the map can be extended to the rest of the field of the asset (play). In this regard, a neural network is designed where the inputs to the network are a set of seismic attributes from the portion of the field of the asset where the NFN map has been generated and the output of the network is the NFN density value generated using the process described above. FIG. 23 is a flow diagram of a method 2300 for mapping the NFN for an entire asset, according to an embodiment.

First, NFN mapping is performed to generate the NFN Density values for a developed portion of a field at step S2302. In this regard, method 100 is employed to generate the NFN density values. Using the developed portion of the field, NFN mapping is performed to generate the NFN Density values for the developed portion of the field.

Then, a reasonably fine Cartesian (or other type of) grid is then imposed on top of the generated map at step S2304. The Cartesian (or other type of) grid is typically one that is already in existence, since it is necessary when generating the distributed NFN Density. The grid is extended to the entire play, including the undeveloped portions of the shale play.

Next, the seismic survey for the entire shale play is then used and the seismic attributes are then selected at step S2306. The seismic attributes are generated without limitation for the entire shale play, including the developed and the undeveloped portions of the play.

Using the seismic attributes for the developed portion of the field and the NFN density for the same portion of the field, a robust neural network model is designed, trained, calibrated, and validated that correlates the seismic attributes to the NFN density at step S2308.

The model is deployed in a forecast mode, and the set of seismic attributes for the rest of the field (play) is used to generate the Natural Fracture Network for the entire field (play), including an undeveloped portion of the field, at step S2310. For example, the trained neural network may be deployed in a predictive (forecast) mode. The seismic attributes (for example, those that were eventually used to train the neural network in the previous step) are used for each Cartesian (or other type of) grid of the undeveloped portion of the field and fed to the trained neural network. The output of the neural network is the NFN density for the given Cartesian (or other type of) grid.

A determination is made as to whether additional undeveloped portions of the field are to be analyzed at step S2312, and if so, method 2300 reiterates at step S2310. If not, the NFN density for the entire undeveloped portion of the shale field is generated and mapped for the entire undeveloped portion of the field at step S2314 and method 2300 ends.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The methods described herein may be executed using a computing device, a simplified block diagram of which is shown in FIG. 19. In an embodiment, the computing device 1900 includes one or more controllers 1902, a memory 1904, and optionally, a display 1906, a network interface 1908, an input device 1910, and/or an output module 1912. The one or more controllers 1902 are configured to receive various information and transform the received information to generate an output. The controller 1902 may include any type of computing device, computational circuit, or any type of processor or processing circuit capable of executing a series of instructions that are stored in a memory. The controller 1902 may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform the one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Any of the herein described methods, programs, algorithms or codes may be contained on one or more machine-readable media or memory 1904. The term “memory” may include a mechanism that provides (e.g., stores and/or transmits) information in a form readable by a machine such a processor, computer, or a digital processing device. For example, the memory 1904 may include a read only memory (ROM), random access memory (RAM), magnetic disk storage media, optical storage media, flash memory devices, or any other volatile or non-volatile memory storage device. Code or instructions contained thereon can be represented by carrier wave signals, infrared signals, digital signals, and by other like signals. The memory 1904 may store an application 1914 and/or data 1916, similar to data and values discussed above with respect to method 100. The application 1914 may, when executed by the controller 1902, cause the method 100 to be performed and to cause the display 1906 to display the data, values, and/or outcomes of the method 100. The network interface 1908 may be configured to connect to a network such as a local area network (LAN) consisting of a wired network and/or a wireless network, a wide area network (WAN), a wireless mobile network, a Bluetooth network, and/or the internet. Input device 1910 may be any device by means of which a user may interact with computing device 1900, such as, for example, a mouse, keyboard, foot pedal, touch screen, and/or voice interface. Output module 1912 may include any connectivity port or bus, such as, for example, parallel ports, serial ports, universal serial busses (USB), or any other similar connectivity port known to those skilled in the art.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A method of generating a map of a Natural Fracture Network (“NFN”) of a shale reservoir, the method comprising:
defining a set of rules to output an NFN density value, the set of rules based on a plurality of parameters including a well volume/completion parameter, a well stimulation parameter, and a well production parameter, each parameter divided into at least two fuzzy clusters, wherein the set of rules includes a plurality of combinations made up of the plurality of parameters and the fuzzy cluster of each parameter, each combination being assigned an NFN density value;
analyzing historical data related to a plurality of wells drilled in the shale reservoir, the data including volume/completion data, stimulation data, and production data;
assigning corresponding values to the historical data based on the set of rules to thereby determine the NFN density value of each of well;
mapping the NFN density value of each well on a graph to thereby identify the NFN of the shale reservoir; and
displaying the graph as the map.

2. The method of claim 1, wherein each of the well volume/completion parameter, the well stimulation parameter, and the well production parameter are divided into three fuzzy clusters.

3. The method of claim 1, wherein each combination is assigned a truth value, and the NFN value is based, in part, on the truth value.

4. The method of claim 1, wherein the well volume/completion parameter is generated from one or more of a well spacing along a lateral length of the hydraulic fracturing job, a bulk volume of the hydraulic fracturing job, initial water saturation to calculate a hydrocarbon pore volume of the hydraulic fracturing job, an initial pressure used in the hydraulic fracturing job, a TOC, or a total number of stages included in the hydraulic fracturing job.

5. The method of claim 4, wherein the well stimulation parameter is generated from one or more of an amount of proppant used in the hydraulic fracturing job or an amount of fluid used in the hydraulic fracturing job.

6. The method of claim 5, wherein the well production parameter is generated from one or more of a well-head pressure used during a hydraulic fracturing job, an initial reservoir pressure used during the hydraulic fracturing job, or a 180 days cumulative production amount obtained from the hydraulic fracturing job.

7. The method of claim 1, wherein:
the shale reservoir includes a developed portion and an undeveloped portion,
the developed portion includes the plurality of wells, and
the method further comprises:
imposing a grid on the generated map;
selecting seismic attributes from a seismic map of the shale reservoir;
using the seismic attributes and NFN density values of the developed portion to design, train, calibrate, and validate a neural network model,
deploying neural network model in a forecast mode,
setting the seismic attributes of the undeveloped portion to generate NFN density values for the shale reservoir including the undeveloped portion, and
generating the map using the NFN density values generated for the undeveloped portion.

8. A non-transitory computer-readable medium storing instructions, which when executed, cause a processor to perform a method of generating a map of a Natural Fracture Network (“NFN”) of a shale reservoir, the method comprising:
defining a set of rules to output an NFN value, the set of rules based on a plurality of parameters including a well volume/completion parameter, a well stimulation parameter, and a well production parameter, each parameter divided into at least two fuzzy clusters, wherein the set of rules includes a plurality of combinations made up of the plurality of parameters and the fuzzy cluster of each parameter, each combination being assigned an NFN density value;
analyzing historical data related to a plurality of wells drilled in the shale reservoir, the data including volume/completion data, stimulation data, and production data;
assigning corresponding values to the historical data based on the set of rules to thereby determine the NFN density value of each of well;
mapping the NFN density value of each well on a graph to thereby identify the NFN of the shale reservoir; and
displaying the graph as the map.

9. The non-transitory computer-readable medium of claim 8, wherein each of the well volume/completion parameter, the well stimulation parameter, and the well production parameter are divided into three fuzzy clusters.

10. The non-transitory computer-readable medium of claim 8, wherein each combination is assigned a truth value, and the NFN value is based, in part, on the truth value.

11. The non-transitory computer-readable medium of claim 8, wherein the well volume/completion parameter is generated from one or more of a well spacing along a lateral length of the hydraulic fracturing job, a bulk volume of the hydraulic fracturing job, initial water saturation to calculate a hydrocarbon pore volume of the hydraulic fracturing job, an initial pressure used in the hydraulic fracturing job, a TOC, or a total number of stages included in the hydraulic fracturing job.

12. The non-transitory computer-readable medium of claim 11, wherein the well stimulation parameter is generated from one or more of an amount of proppant used in the hydraulic fracturing job or an amount of fluid used in the hydraulic fracturing job.

13. The non-transitory computer-readable medium of claim 12, wherein the well production parameter is generated from one or more of a well-head pressure used during a hydraulic fracturing job, an initial reservoir pressure used during the hydraulic fracturing job, or a 180 days cumulative production amount obtained from the hydraulic fracturing job.

14. The non-transitory computer-readable medium of claim 8, wherein:
the shale reservoir includes a developed portion and an undeveloped portion,
the developed portion includes the plurality of wells, and
the method further comprises:
imposing a grid on the generated map;
selecting seismic attributes from a seismic map of the shale reservoir;
using the seismic attributes and NFN density values of the developed portion to design, train, calibrate, and validate a neural network model,
deploying neural network model in a forecast mode,
setting the seismic attributes of the undeveloped portion to generate NFN density values for the shale reservoir including the undeveloped portion, and
generating the map using the NFN density values generated for the undeveloped portion.
